(19) United States
(12) Patent Application Publication
(10) Pub. No.: US 2014/0250703 A1
(43) Pub. Date: Sep. 11, 2014

(54) PORTABLE DEVICE FOR PUNCTURING METAL CANS

(71) Applicant: David R. Aden, Midland, MI (US)

(72) Inventor: David R. Aden, Midland, MI (US)

(21) Appl. No.: 13/789,720

(22) Filed: Mar. 8, 2013

(51) Int. Cl. B26F 1/32

(52) U.S. Cl. CPC B26F 1/32
USPC 30/443

(57) ABSTRACT

A device for puncturing metal cans. The device is placed against the can and, when a small force is applied, it is designed to uniformly puncture the can leaving a consistent hole.

### BACKGROUND OF THE INVENTION

The use of objects to create a secondary hole in a metal can is not new to the art. However, most are not objects design to uniformly puncture the can, and thus, puncture an inconsistent hole or potentially tear the can. There are prior art devices that are known such as U.S. Pat. No. 7,861,900 entitled “Fluid Dispensing System” issued to Kevin A. Ryan, on Jan. 4, 2011 which penetrates the can in the lower portion of the can to create an air flow when the top portion of the can is opened, allowing the contents to be quickly consumed. This system is essentially backwards to the common practice by using the upper portion for ingestion purposes.

The device has a release value within it to prevent back flow. It has been discovered that the insertion of the device causes leakage and relegates the check valve useless as fluid seeps and streams around the device. This operation is messy and requires clean up and the process cannot be performed anywhere.

Also present is a device called “Flowzie” which claims a patent pending status but the applicant was unable to find any reference to such a device in the USPTO applications or publications. Regardless, the device also suffers from some of the same limitations that the other prior art devices do. Its operation is again backward to the common practice of using the punctured hole for ingestion of the fluid instead of using the container opening for consumption. The flowzie is essentially a can insulated can holder with a device that punctures a hole in a can once the can is inserted into the holder. The can is then opened, tipped on its side, with the flowzie device in the top side of the open can, and then activated, causing the fluid to rush out. If the can is not perfectly placed within the holder the operation will fail and fluid will rush out uncontrollably, again creating a mess.

The flowzie also suffers a further complication, in that, the hole that is created is extremely small in diameter and does not allow for a larger or faster flow out of the liquid.

It also has limited application, in that, if a group of people wished to celebrate together they must all have a flowzie, the current invention allows the group to all puncture their cans and then all at once they tip up their cans and pop the tops and the celebration begins. The current device is capable of being attached to a key chain or something similar. The device is small and convenient to carry and store.

In addition, the device of this invention can have a bottle cap opener built into the housing for convenience.

### THE INVENTION

The present invention is a portable device for puncturing metal cans. The portable device comprises a housing that has a hub configuration. The housing has a top end and a bottom end. The bottom end has affixed thereto, a circumferential flange. This housing has an opening centered therein. There is a punch assembly located in the housing. The punch assembly comprises a shaft that has a bottom end and a top end. The bottom end is pointed. The shaft has a stepped diameter and a cap on the top end. The shaft has free movement within the housing.

### BRIEF DESCRIPTION OF THE DRAWINGS

FIG. 1 is a view in perspective of a portable device of this invention.

FIG. 2 is a view in perspective of a portable device of this invention, partially deployed.

FIG. 3 is a view in perspective of a portable device of this invention, fully deployed.

FIG. 4 is a view in perspective of a portable device of this invention, against a metal can undeployed.

FIG. 5 is a view of FIG. 4 wherein the device is deployed.

FIG. 6 is a view in perspective of a housing of the portable device for puncturing metal cans.

FIG. 7 is a view in perspective of the punch assembly of the portable device for puncturing metal cans.

FIG. 8 is a view in perspective of a housing of this invention showing the opening in the housing of the portable device for uncapping bottles.

FIG. 9 is a view in perspective of the housing of this invention showing a key chain attachment.

### DETAILED DESCRIPTION OF THE DRAWINGS

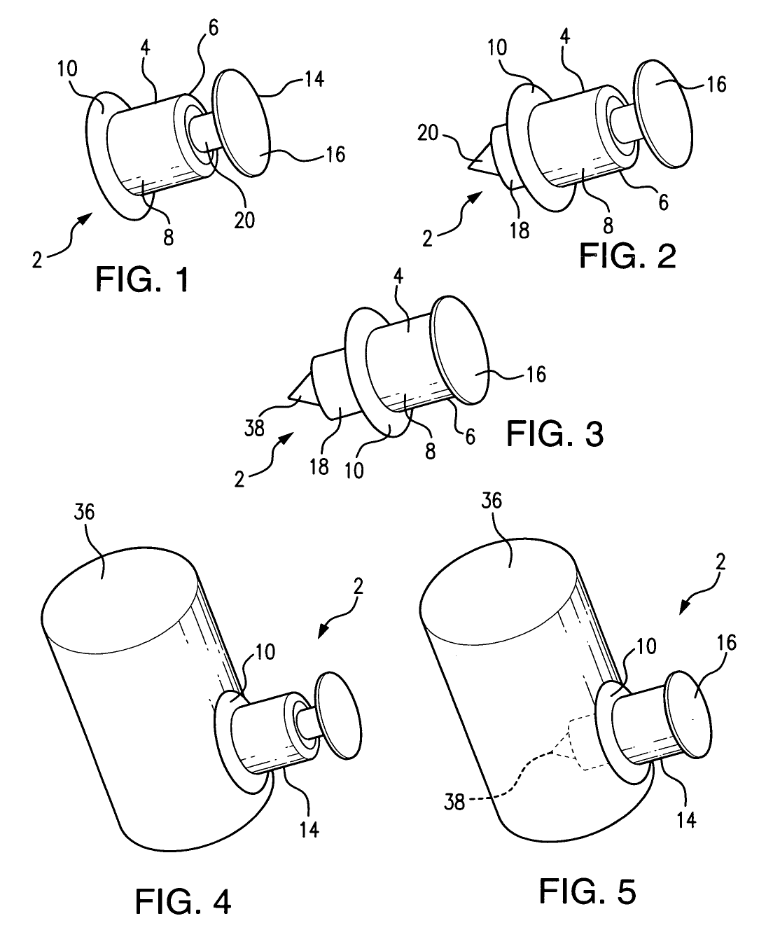

FIG. 1 shows the portable device for puncturing metal cans 2. The device 2 has a housing 4 that contains the punch assembly 14. The punch assembly 14 has a top 16, a bottom 18(not shown in this Figure) and a shaft 20. The housing 4 also has a top 6 and a bottom 8. At the bottom 8 of housing 4 is a flange 10 that interfaces with the can 36 (not shown Figure).

FIG. 2 shows the portable device for puncturing metal cans 2 partially deployed. The device 2 has a housing 4, with a top 6, a bottom 8 and a flange 10. The punch assembly 14 also has a top 16, a bottom 18 and the bottom of the punch has a point 38.

FIG. 3 shows the portable device for puncturing metal cans 2 fully deployed. What is shown is the relationship between the bottom 18 of the punch assembly 14 and the point 38. When the top 16 is compressed the shaft point 38 will puncture the side of the can 36 (not shown). Also shown are the housing 4, the top 6 and the bottom 8 of the device for puncturing metal cans.

FIG. 4 shows the portable device for puncturing metal cans 2 against a metal can 36 undeployed. The punch 14 is resting against the can 36 with the flange 10 seated firmly against the can 36.

FIG. 5 shows the portable device for puncturing metal cans 2 against a metal can 36 deployed. Here the top 16 of the punch 14 is compressed it forces the shaft point 38 (shown in phantom) through the side of the can 36. This action forms a consistent puncture through the can 36. The flange 10 is used to hold the device to the can and helps prevent the flow of the product from the can 36. Now the user can easily and cleanly create the desired opening.

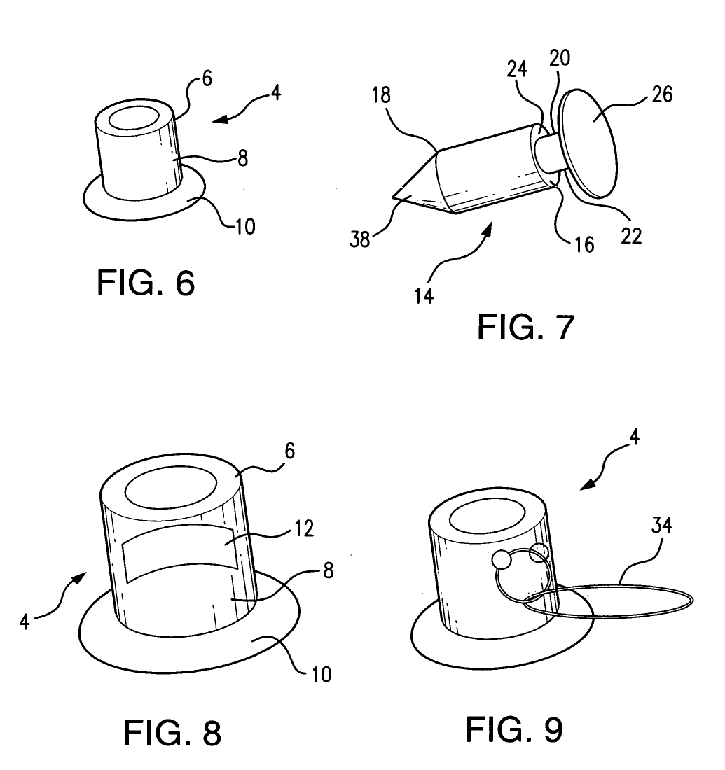

FIG. 6 shows housing 4 of the portable device for puncturing metal cans 2. The housing 4 has a top 6, a bottom 8 and the flange 10.

FIG. 7 shows the punch 14 assembly of the portable device for puncturing metal cans 2. The punch 14 has a top 16, a bottom 18 and a shaft 20. This shaft 20 has a top 22, a bottom 24 and a shaft stop or cap 26. The bottom 18 of the punch 14 contains the shaft point 38 for puncturing the can 36.

FIG. 8 shows the opening 12 in the housing 4 of the portable device for puncturing metal cans 2 that is a bottle opener 12.

FIG. 9 shows the key chain attachment point 34 of the portable device for puncturing metal cans 2.

What is claimed is:

1. A portable device for puncturing metal cans, said portable device comprising:
a. a housing having a hub configuration, said housing having a top end and a bottom end, said bottom end having affixed thereto, a circumferential flange;
b. said housing having an opening centered therein;
c. a punch assembly located in said housing, said punch assembly comprising a shaft having a bottom end and a top end, said bottom end being pointed, said shaft having a stepped diameter and a cap on said top end, said shaft having free movement within said housing.

2. A portable device as claimed in claim 1 wherein said cap is threaded onto said top end of said shaft.

3. A portable device as claimed in claim 1 wherein said cap is compressed onto said top end of said shaft.

4. A portable device as claimed in claim 1, wherein, in addition, there is a cut out section in a side of said housing that can serve as a bottle opener.

5. A portable device as claimed in claim 1, wherein, in addition, there is a key chain attachment attached to said housing.
